(19) United States
(12) Patent Application Publication
(10) Pub. No.: US 2019/0045483 A1
(43) Pub. Date: Feb. 7, 2019

(54) Methods for Device-to-Device Communication and Off Grid Radio Service

(71) Applicant: Apple Inc., Cupertino, CA (US)

(72) Inventors: Tarik Tabet, Los Gatos, CA (US); Lydi Smaini, San Jose, CA (US); Ronald W. Dimpflmaier, Los Gatos, CA (US); Matthias Sauer, San Jose, CA (US); Jason C. Fan, Los Altos, CA (US)

(21) Appl. No.: 16/053,186

(22) Filed: Aug. 2, 2018

Related U.S. Application Data
(60) Provisional application No. 62/542,069, filed on Aug. 7, 2017.

(51) Int. Cl. H04W 72/00; H04W 56/00; H04W 4/06; H04W 48/10; H04W 72/08; H04W 36/00

(52) U.S. Cl. CPC H04W 72/005; H04W 56/001; H04W 4/06; H04W 84/20; H04W 72/085; H04W 36/0007; H04W 48/10

(57) ABSTRACT

This disclosure relates to techniques for supporting narrowband device-to-device wireless communication, including possible techniques for 1) handing off from one master to another and 2) relaying shifted device-to-device synchronization signals in an off grid radio system. The techniques herein may allow for a successor master device to take over a master role, including by transmitting synchronization signals. The techniques herein may allow for a repeater device to expand the boundary of a device-to-device communication group by transmitting synchronization signals that are shifted relative to synchronization signals transmitted by a master device.

### PRIORITY CLAIM

This application claims priority to U.S. provisional patent application Ser. No. 62/542,069, entitled “Methods for Device-to-Device Communication and Off Grid Radio Service,” filed Aug. 7, 2017, which is hereby incorporated by reference in its entirety as though fully and completely set forth herein.

### TECHNICAL FIELD

The present application relates to wireless communication, including to techniques for performing narrowband device-to-device wireless communication.

### DESCRIPTION OF THE RELATED ART

Wireless communication systems are rapidly growing in usage. Further, wireless communication technology has evolved from voice-only communications to also include the transmission of data, such as Internet and multimedia content.

Mobile electronic devices may take the form of smart phones or tablets that a user typically carries. Wearable devices (also referred to as accessory devices) are a newer form of mobile electronic device, one example being smart watches. Additionally, low-cost low-complexity wireless devices intended for stationary or nomadic deployment are also proliferating as part of the developing “Internet of Things”. In other words, there is an increasingly wide range of desired device complexities, capabilities, traffic patterns, and other characteristics. In general, it would be desirable to recognize and provide improved support for a broad range of desired wireless communication characteristics. One area of rapid change is the field of device-to-device (D2D) wireless communication.

### SUMMARY

Embodiments are presented herein of, inter alia, systems, apparatuses, and methods for performing device-to-device (D2D) wireless communication.

A master device may broadcast D2D synchronization signals to allow other devices to discover each other and communicate. Methods described herein may allow for efficient handoff of the master role between devices.

It may be generally useful for devices in one D2D communication group to be able to synchronize with, discover, or communicate with nearby devices if they are in different D2D communication groups. Accordingly, methods are described herein for rebroadcasting of synchronization signals by slave devices under certain conditions in order to expand the reach of the D2D communication group and to allow devices to communicate with additional groups.

The techniques described herein may be implemented in and/or used with a number of different types of devices, including but not limited to cellular phones, tablet computers, accessory and/or wearable computing devices, portable media players, cellular base stations and other cellular network infrastructure equipment, servers, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including an accessory device, according to some embodiments;

FIG. 2 illustrates an example wireless communication system in which two wireless devices can perform direct device-to-device communication, according to some embodiments;

FIG. 3 is a block diagram illustrating an example wireless device, according to some embodiments;

FIG. 4 is a block diagram illustrating an example base station, according to some embodiments;

FIG. 5 is a communication flow diagram illustrating an exemplary method for performing narrowband device-to-device wireless communication, according to some embodiments;

FIG. 6 illustrates aspects of an exemplary cellular network supported device-to-device communication architecture, according to some embodiments;

FIG. 7 illustrates various possible device-to-device communication related operations in an exemplary cellular network supported device-to-device communication framework, according to some embodiments;

FIG. 8 is a flowchart diagram illustrating an exemplary method for determining how to perform synchronization for device-to-device communications when out-of-coverage in an exemplary cellular network supported D2D communication framework, according to some embodiments;

FIG. 9 is a flowchart diagram illustrating an exemplary process for creating an overlap region at the edge of a D2D communication group, according to some embodiments;

FIG. 10 is a flowchart diagram illustrating an exemplary process for handoff of the master role from a wireless device, according to some embodiments;

FIGS. 11-13 depict exemplary D2D communication groups according to various embodiments;

FIGS. 14 and 15 depict a D2D communication group changing in various ways according to various embodiments of the methods described herein;

FIGS. 16 and 17 are timing diagrams illustrating an exemplary process for handoff of the master role from a wireless device, according to some embodiments; and

FIG. 18 depicts exemplary thresholds according to various embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

The following acronyms are used in the present disclosure.

3GPP: Third Generation Partnership Project

3GPP2: Third Generation Partnership Project 2

GSM: Global System for Mobile Communications

UMTS: Universal Mobile Telecommunications System

LTE: Long Term Evolution

OGRS: Off Grid Radio Service

IoT: Internet of Things

NB: Narrowband

D2D: device-to-device

OOC: out-of-coverage

### Terminology

The following are definitions of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that performs wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” (also called “eNB”) has the full breadth of its ordinary meaning, and at least includes a wireless communication station installed at a fixed location and used to communicate as part of a wireless cellular communication system.

Link Budget Limited—includes the full breadth of its ordinary meaning, and at least includes a characteristic of a wireless device (e.g., a UE) which exhibits limited communication capabilities, or limited power, relative to a device that is not link budget limited, or relative to devices for which a radio access technology (RAT) standard has been developed. A wireless device that is link budget limited may experience relatively limited reception and/or transmission capabilities, which may be due to one or more factors such as device design, device size, battery size, antenna size or design, transmit power, receive power, current transmission medium conditions, and/or other factors. Such devices may be referred to herein as “link budget limited” (or “link budget constrained”) devices. A wireless/UE device may be inherently link budget limited due to its size, battery power, and/or transmit/receive power, e.g., due to hardware limitations of the wireless device. For example, a smart watch or other accessory device that is communicating over LTE or LTE-A with a base station may be inherently link budget limited due to its reduced transmit/receive power and/or reduced antenna. Wearable devices, such as smart watches, are generally link budget limited devices. Alternatively, a device may not be inherently link budget limited, e.g., may have sufficient size, battery power, and/or transmit/receive power for normal communications over LTE or LTE-A, but may be temporarily link budget limited due to current communication conditions, e.g., a smart phone being at the edge of a cell, etc. It is noted that the term “link budget limited” includes or encompasses power limitations, and thus a power limited device may be considered a link budget limited device.

Processing Element (or Processor)—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

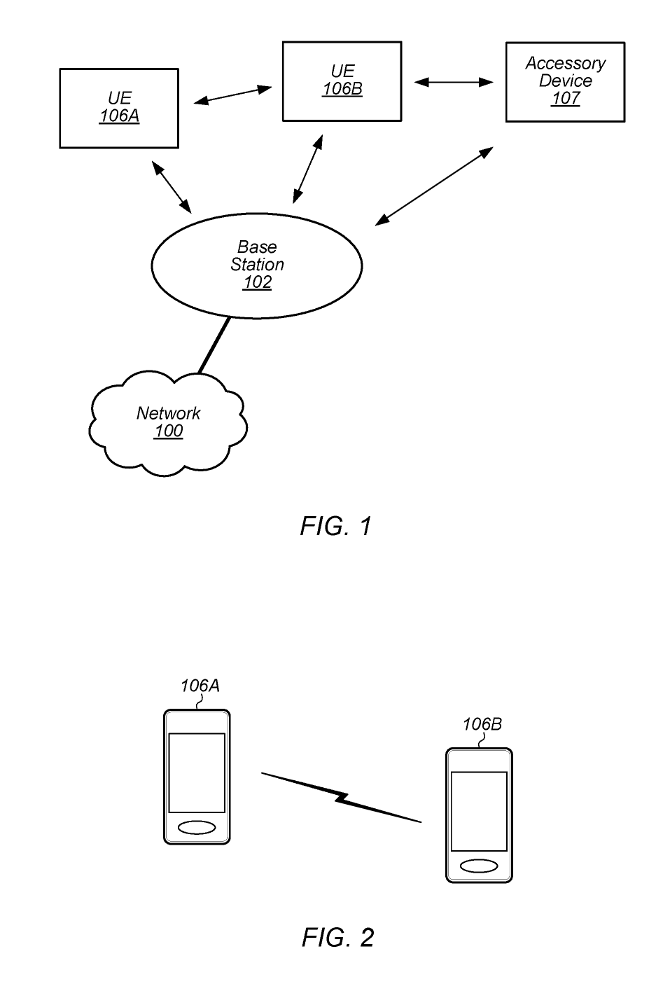

### FIG. 1—Wireless Communication System

FIG. 1 illustrates an example of a wireless cellular communication system. It is noted that FIG. 1 represents one possibility among many, and that features of the present disclosure may be implemented in any of various systems, as desired. For example, embodiments described herein may be implemented in any type of wireless device.

As shown, the exemplary wireless communication system includes a cellular base station 102, which communicates over a transmission medium with one or more wireless devices 106A, 106B, etc., as well as accessory device 107. Wireless devices 106A, 106B, and 107 may be user devices, which may be referred to herein as “user equipment” (UE) or UE devices.

The base station 102 may be a base transceiver station (BTS) or cell site, and may include hardware that enables wireless communication with the UE devices 106A, 106B, and 107. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the UE devices 106 and 107 and/or between the UE devices 106/107 and the network 100. In other implementations, base station 102 can be configured to provide communications over one or more other wireless technologies, such as an access point supporting one or more WLAN protocols, such as 802.11 a, b, g, n, ac, ad, and/or ax, or LTE in an unlicensed band (LAA).

The communication area (or coverage area) of the base station 102 may be referred to as a “cell.” The base station 102 and the UEs 106/107 may be configured to communicate over the transmission medium using any of various radio access technologies (RATs) or wireless communication technologies, such as GSM, UMTS (WCDMA, TDS-CDMA), LTE, LTE-Advanced (LTE-A), NR, OGRS, HSPA, 3GPP2 CDMA2000 (e.g., 1xRTT, 1xEV-DO, HRPD, eHRPD), Wi-Fi, etc.

Base station 102 and other similar base stations (not shown) operating according to one or more cellular communication technologies may thus be provided as a network of cells, which may provide continuous or nearly continuous overlapping service to UE devices 106A-N and 107 and similar devices over a geographic area via one or more cellular communication technologies.

Note that at least in some instances a UE device 106/107 may be capable of communicating using any of multiple wireless communication technologies. For example, a UE device 106/107 might be configured to communicate using one or more of GSM, UMTS, CDMA2000, LTE, LTE-A, NR, OGRS, WLAN, Bluetooth, one or more global navigational satellite systems (GNSS, e.g., GPS or GLONASS), one and/or more mobile television broadcasting standards (e.g., ATSC-M/H), etc. Other combinations of wireless communication technologies (including more than two wireless communication technologies) are also possible. Likewise, in some instances a UE device 106/107 may be configured to communicate using only a single wireless communication technology.

The UEs 106A and 106B may include handheld devices such as smart phones or tablets, and/or may include any of various types of device with cellular communications capability. For example, one or more of the UEs 106A and 106B may be a wireless device intended for stationary or nomadic deployment such as an appliance, measurement device, control device, etc. The UE 106B may be configured to communicate with the UE device 107, which may be referred to as an accessory device 107. The accessory device 107 may be any of various types of wireless devices, typically a wearable device that has a smaller form factor, and may have limited battery, output power and/or communications abilities relative to UEs 106. As one common example, the UE 106B may be a smart phone carried by a user, and the accessory device 107 may be a smart watch worn by that same user. The UE 106B and the accessory device 107 may communicate using any of various short range communication protocols, such as Bluetooth or Wi-Fi.

### FIG. 2—Device-to-Device Communication

The UE 106B may also be configured to communicate with the UE 106A. For example, the UE 106A and UE 106B may be capable of performing direct device-to-device (D2D) communication (e.g., Off Grid Radio Service or OGRS). The D2D communication may be supported by the cellular base station 102 (e.g., the BS 102 may facilitate discovery, among various possible forms of assistance), or may be performed in a manner unsupported by the BS 102. In some embodiments, BS 102 may not be present in the vicinity of UEs 106 A and 106B. For example, according to at least some aspects of this disclosure, the UE 106A and UE 106B may be capable of arranging and performing narrowband D2D communication with each other even when out-of-coverage (OOC) of the BS 102 and other cellular base stations.

FIG. 2 illustrates example UE devices 106A, 106B in D2D communication with each other. The UE devices 106A, 106B may be any of a mobile phone, a tablet, or any other type of hand-held device, a smart watch or other wearable device, a media player, a computer, a laptop or virtually any type of wireless device.

The UEs 106A and 106B may each include a device or integrated circuit for facilitating cellular communication, referred to as a cellular modem. The cellular modem may include one or more processors (processing elements) and various hardware components as described herein. The UEs 106A and 106B may each perform any of the method embodiments described herein, e.g., by executing instructions on one or more programmable processors. Alternatively, or in addition, the one or more processors may be one or more programmable hardware elements such as an FPGA (field-programmable gate array), or other circuitry, that is configured to perform any of the method embodiments described herein, or any portion of any of the method embodiments described herein. The cellular modem described herein may be used in a UE device as defined herein, a wireless device as defined herein, or a communication device as defined herein. The cellular modem described herein may also be used in a base station or other similar network side device.

The UEs 106A and 106B may include one or more antennas for communicating using two or more wireless communication protocols or radio access technologies. In some embodiments, one or both of the UE 106A or UE 106B might be configured to communicate using a single shared radio. The shared radio may couple to a single antenna, or may couple to multiple antennas (e.g., for MIMO) for performing wireless communications. Alternatively, the UE 106A and/or UE 106B may include two or more radios. Other configurations are also possible.

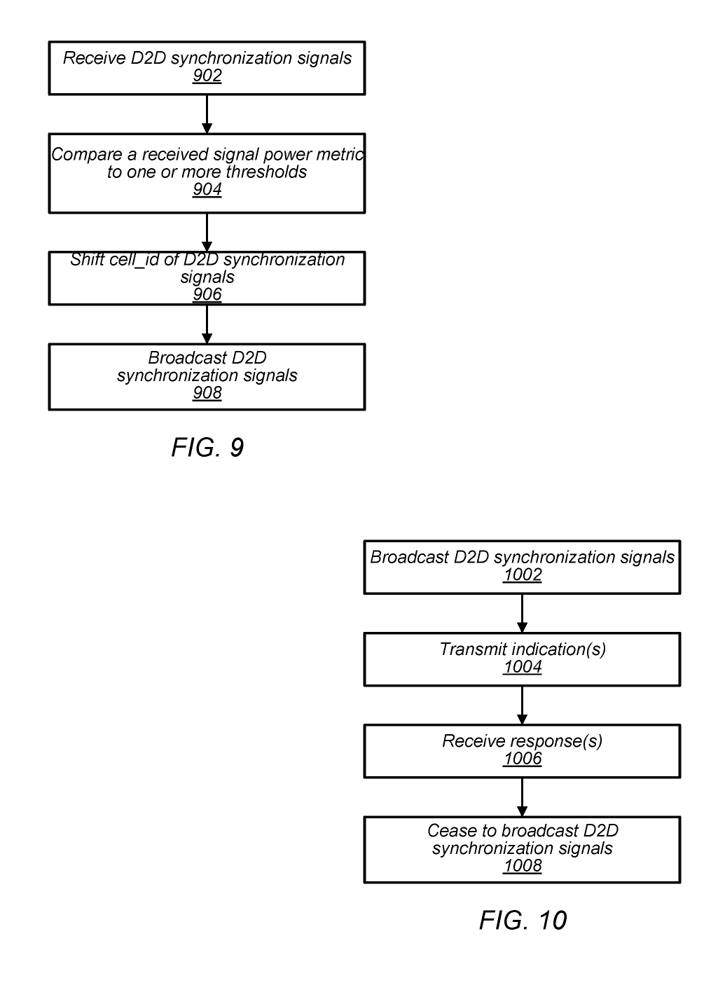

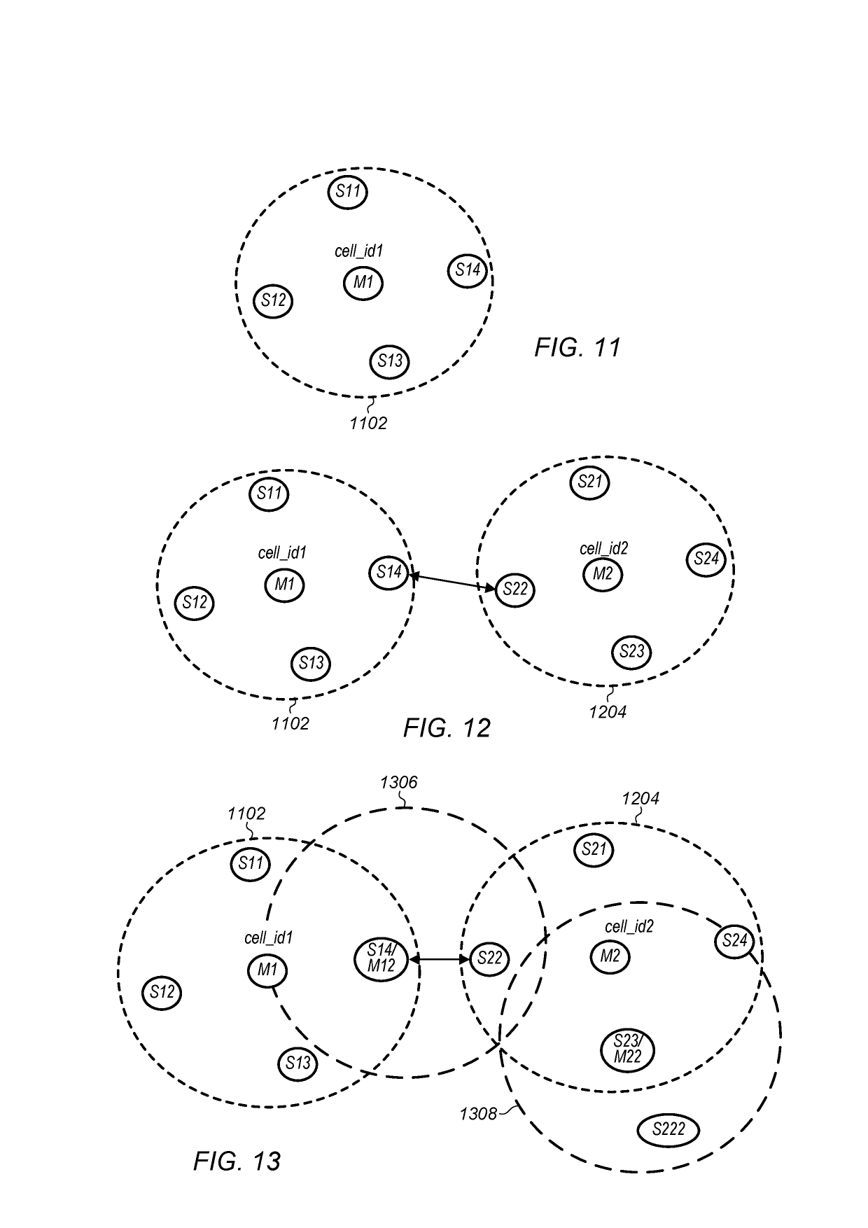

Off Grid Radio Service (OGRS) is a system that is being developed to provide long range peer-to-peer (P2P)/D2D communication, e.g., in absence of a wide area network (WAN) or WLAN radio connection to support a variety of possible features. At least according to some embodiments, OGRS systems may support some or all of the features described herein, such as any of the features or steps of the method of FIGS. 9 and 10. FIGS. 11-16 and the following additional information are provided as being illustrative of a variety of further possible features and details of a possible Off Grid Radio Service (OGRS) communication system, and are not intended to be limiting to the disclosure as a whole. Numerous variations and alternatives to the details provided herein below are possible and should be considered within the scope of the disclosure.

According to some embodiments, OGRS may operate in unlicensed low (e.g., industrial, scientific, and medical (ISM)) bands, e.g., between 700 MHz and 1 GHz or in 2.4 GHZ ISM band, for extended range purposes, and may use one or multiple carriers of approximately 200 kHz. OGRS may be designed to meet the local spectrum regulatory requirements, such as channel duty cycle, operating frequencies, hopping pattern, LBT, maximum transmit power, and occupied bandwidth.

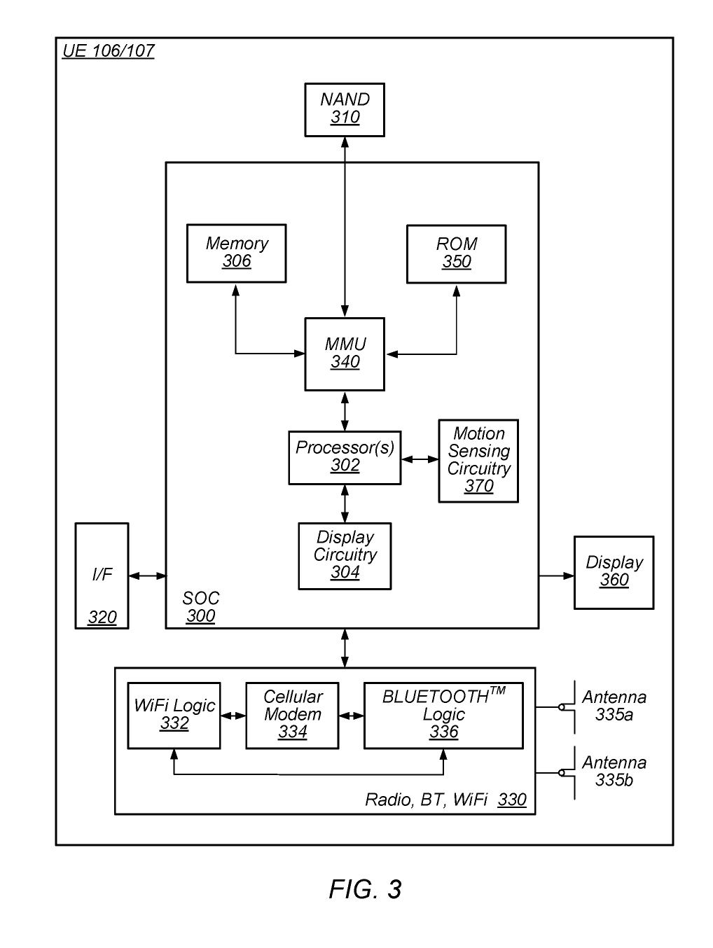

### FIG. 3—Block Diagram of a UE Device

FIG. 3 illustrates one possible block diagram of an UE device, such as UE device 106 or 107. As shown, the UE device 106/107 may include a system on chip (SOC) 300, which may include portions for various purposes. For example, as shown, the SOC 300 may include processor(s) 302 which may execute program instructions for the UE device 106/107, and display circuitry 304 which may perform graphics processing and provide display signals to the display 360. The SOC 300 may also include motion sensing circuitry 370 which may detect motion of the UE 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g., memory 306, read only memory (ROM) 350, flash memory 310). The MMU 340 may be configured to perform memory protection and page table translation or set up. In some embodiments, the MMU 340 may be included as a portion of the processor(s) 302.

As shown, the SOC 300 may be coupled to various other circuits of the UE 106/107. For example, the UE 106/107 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, OGRS, CDMA2000, Bluetooth, Wi-Fi, NFC, GPS, etc.).

The UE device 106/107 may include at least one antenna, and in some embodiments multiple antennas 335a and 335b, for performing wireless communication with base stations and/or other devices. For example, the UE device 106/107 may use antennas 335a and 335b to perform the wireless communication. As noted above, the UE device 106/107 may in some embodiments be configured to communicate wirelessly using a plurality of wireless communication standards or radio access technologies (RATs).

The wireless communication circuitry 330 may include Wi-Fi Logic 332, a Cellular Modem 334, and Bluetooth Logic 336. The Wi-Fi Logic 332 is for enabling the UE device 106/107 to perform Wi-Fi communications on an 802.11 network. The Bluetooth Logic 336 is for enabling the UE device 106/107 to perform Bluetooth communications. The cellular modem 334 may be a lower power cellular modem capable of performing cellular communication according to one or more cellular communication technologies.

As described herein, UE 106/107 may include hardware and software components for implementing embodiments of this disclosure. For example, one or more components of the wireless communication circuitry 330 (e.g., cellular modem 334) of the UE device 106/107 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

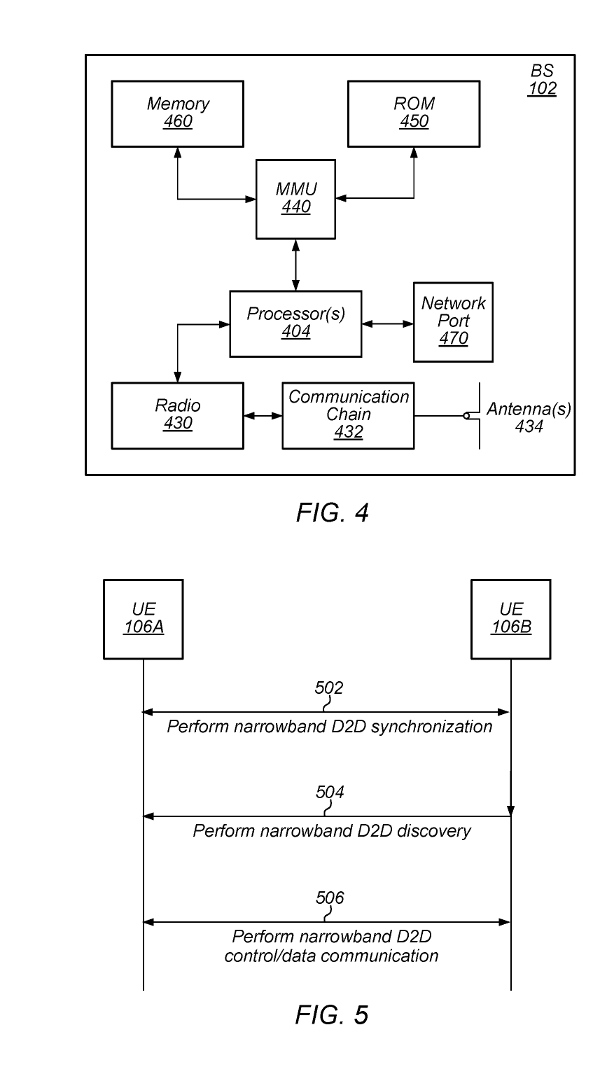

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106/107, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106/107. For example, the core network may include a mobility management entity (MME), e.g., for providing mobility management services, a serving gateway (SGW) and/or packet data network gateway (PGW), e.g., for providing external data connections such as to the Internet, etc. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106/107 via radio 430. The antenna(s) 434 communicates with the radio 430 via communication chain 432. Communication chain 432 may be a receive chain, a transmit chain or both. The radio 430 may be configured to communicate via various wireless communication standards, including, but not limited to, LTE, LTE-A, NR, OGRS, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a Wi-Fi radio for performing communication according to Wi-Fi. In such a case, the base station 102 may be capable of operating as both an LTE base station and a Wi-Fi access point. As another possibility, the base station 102 may include a multi-mode radio which is capable of performing communications according to any of multiple wireless communication technologies (e.g., LTE and Wi-Fi, LTE and UMTS, LTE and CDMA2000, UMTS and GSM, etc.).

As described further subsequently herein, the BS 102 may include hardware and software components for implementing or supporting implementation of features described herein. For example, while many of the features described herein relate to device-to-device communication that can be performed by UE devices without relying on an intermediary base station, a cellular base station may be configured to also be capable of performing device-to-device communication in accordance with the features described herein. As another possibility, the BS 102 may be instrumental in configuring a UE 106 to perform narrowband device-to-device communication according to the features described herein, and/or certain features described herein may be performed or not performed by a device based at least in part on whether there is a BS 102 providing cellular service within range of the device. According to some embodiments, the processor 404 of the base station 102 may be configured to implement part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

### FIG. 5—Communication Flow Diagram

FIG. 5 is a communication flow diagram illustrating a method for performing narrowband device-to-device wireless communication. In various embodiments, some of the elements of the methods shown may be performed concurrently, in a different order than shown, may be substituted for by other method elements, or may be omitted. Additional method elements may also be performed as desired.

Aspects of the method of FIG. 5 may be implemented by a wireless device, such as the UEs 106A-B or 107 illustrated in and described with respect to FIGS. 1-3, or more generally in conjunction with any of the computer systems or devices shown in the above Figures, among other devices, as desired. Note that while at least some elements of the method of FIG. 5 are described in a manner relating to the use of communication techniques and/or features associated with LTE, OGRS, and/or 3GPP specification documents, such description is not intended to be limiting to the disclosure, and aspects of the method of FIG. 5 may be used in any suitable wireless communication system, as desired. As shown, the method may operate as follows.

In 502, the wireless device (e.g., UE 106A) may perform device-to-device (D2D) synchronization (e.g., with a second wireless device, e.g., UE 106B). The D2D synchronization may be performed on a frequency channel having a frequency width of one physical resource block (PRB), e.g., approximately 200 kHz according to some embodiments. In some instances, multiple such “narrowband” frequency channels may be used to perform the synchronization. For example, two PRBs may be used for synchronization in some embodiments, e.g., related to D2D using multiple different cellular IDs. Alternatively, or additionally, a plurality of PRBs (e.g., six PRBs) may be used in some embodiments, such as those where a single cell_id is used for multiple D2D communication groups. Other resources (e.g., channels and/or numbers of PRBs) may be used as desired.

According to some embodiments, the D2D synchronization may be performed while the wireless device is out-of-coverage (OOC), e.g., with respect to any cellular base stations (or at least with respect to cellular base stations with which the wireless device is configured to communicate). In such a case, the wireless device may determine that it is OOC and may monitor appropriate resources (e.g., a sidelink communication band, among other possibilities) for D2D synchronization signals (e.g., Narrowband IoT D2D Primary/Secondary Synchronization Signals (NDPSS/NDSSS)) based on determining that the wireless device is OOC. If the wireless device is unable to decode any synchronization signals while monitoring the resources, the wireless device may transmit D2D synchronization signals itself If the wireless device is able to receive and decode synchronization signals, the wireless device may synchronize with those signals.

According to some embodiments, the D2D synchronization signals may include primary and secondary synchronization signals. In some embodiments, the D2D synchronization signals may be based on NarrowBand IoT (NB-IoT) technology, such as may be considered or adopted by 3GPP, among other possibilities. In exemplary embodiments, such signals may be NDPSS/NDSSS. Additionally, or alternatively, D2D synchronization signals may be referred to variously as sidelink narrowband primary synchronization signals (SNPSS), direct narrowband primary synchronization signals (DNPSS), sidelink narrowband secondary synchronization signals (SNSSS), direct narrowband secondary synchronization signal (DNSSS), primary/secondary sidelink synchronization signals (PSSS/SSSS), or in any of various other manners. The synchronization signals may further include a D2D master information block (MIB), which may be transmitted on various channels such as described by NB-IoT or a sidelink narrowband physical broadcast channel (SNPBCH), in some embodiments. Alternatively, the MIB may be considered separate from the synchronization signals, according to some embodiments. The synchronization signals may be collocated with respect to a frequency channel (e.g., may be transmitted in the same 1PRB frequency channel or same set of narrowband frequency channels). The D2D MIB may indicate which portions of the frequency channel are allocated for any or all of D2D synchronization signals, D2D discovery messages, D2D control communications, and/or D2D data communications. Alternatively, at least some of these allocations may be indicated in discovery messages or in other messages.

In 504, the wireless device may perform D2D discovery with a second wireless (e.g., UE 106B) device. The D2D discovery may be performed using various resources. Such resources may be determined based on the D2D synchronization signals or otherwise may be determined using NB-IoT techniques. In some embodiments, discovery may be performed using a sidelink narrowband physical discovery channel (SNPDCH) or other discovery channel allocated within a frequency channel comprising a frequency width of one PRB, or may be performed using multiple such narrowband frequency channels, according to some embodiments.

In 506, the wireless device may perform D2D communication, e.g., including control and/or data communications, with the second wireless device. Control communication may be performed using NB-IoT techniques, among other possibilities. Control communication may be performed using a sidelink narrowband physical control channel (SNPCCH) and data communication may be performed using a sidelink narrowband physical shared channel (SNPSCH), according to some embodiments. The control and/or data communications may be performed in a different (e.g., 1PRB) frequency channel or set of frequency channels than the synchronization and/or discovery communications, if desired, or may be performed in the same frequency channel or set of frequency channels as the synchronization and/or discovery communications. For example, two or more frequency channels each comprising a frequency width of one PRB may be aggregated to perform the D2D discovery and communication, such that a first frequency channel is used for D2D discovery, and a second frequency channel is used for D2D control and data communications, as one possibility.

Note also that, if desired, a frequency hopping scheme may be employed with respect to the narrowband D2D communication. For example, the wireless device may periodically hop to a different frequency channel (e.g., also comprising a frequency width of one PRB) to perform the D2D synchronization, discovery, and communication according to a predetermined frequency hopping pattern. Other wireless devices following the same synchronization scheme may also follow the same frequency hopping pattern. For example, frequency hopping for synchronization and MIB transmission may be performed according to a scheme configured such that the average amount of time that a wireless device transmits on any given frequency channel is below a desired value (e.g., below a duty cycling parameter), according to some embodiments.

Note still further that, if desired, listen-before-talk (LBT) techniques may be employed with respect to the narrowband D2D communication. For example, the wireless device may perform a LBT procedure prior to transmitting D2D discovery, control, or data messages, according to some embodiments. At least in some instances, it may be the case that no LBT procedure is performed prior to transmitting D2D synchronization signals, e.g., even if LBT procedures are performed prior to transmitting D2D discovery, control, or data messages.

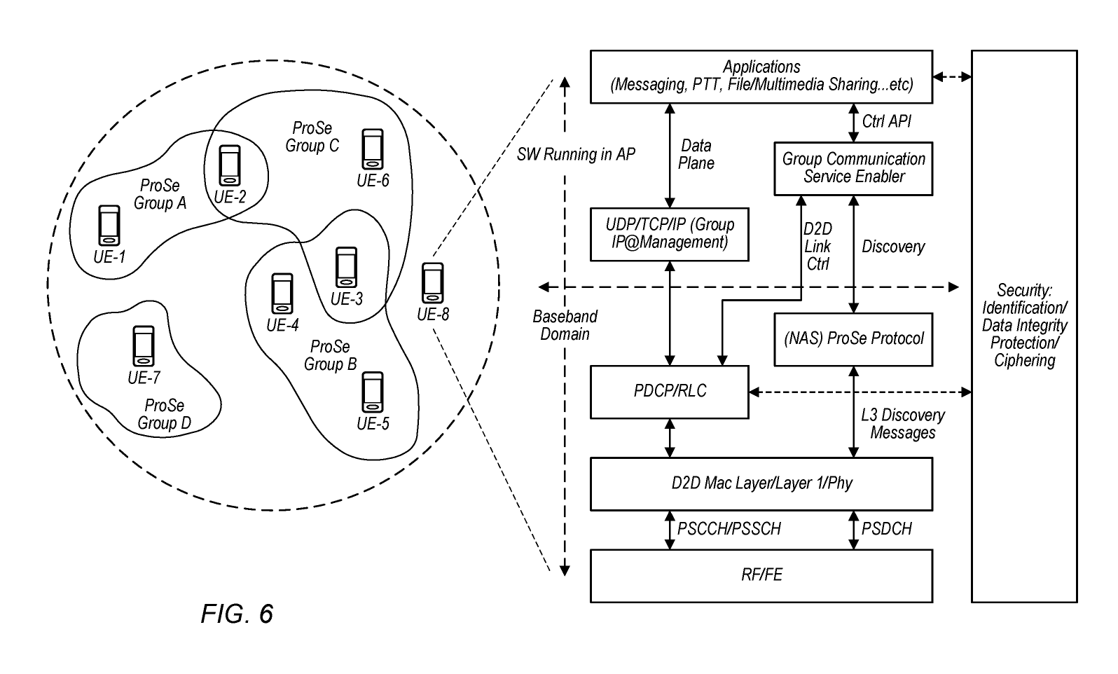

### FIGS. 6-8—Cellular Network Supported D2D Communications

FIG. 6 illustrates aspects of an exemplary cellular network supported device-to-device communication architecture, according to some embodiments. In particular, an end-to-end architecture for 3GPP “ProSe” (proximity services) direct link communication is shown, in which various UEs form ProSe groups (e.g., ProSe groups A-D, which may overalap). Each UE participating in such ProSe communication may implement a ProSe stack, including applications and user datagram protocol (UDP), transport control protocol (TCP), and/or internet protocol (IP) layers in software (SW) executing on an application processor, along with a group communication service enabler. The ProSe stack may also include a packet data convergence protocol (PDCP), radio link control (RLC) layer, a non-access stratum (NAS) ProSe protocol layer, a D2D media access control (MAC) layer, layer 1, and/or physical (PHY) layer, as well as a RF front end (RF/FE), implemented in the baseband domain. The ProSe stack may also include a security layer for identification, data integrity protection, and/or ciphering. As noted above, various embodiments of this disclosure may be implemented without cellular network support (e.g., in OOC scenarios, OGRS, etc.). Thus, in various embodiments, ProSe groups, ProSe protocols, etc., may not be employed.

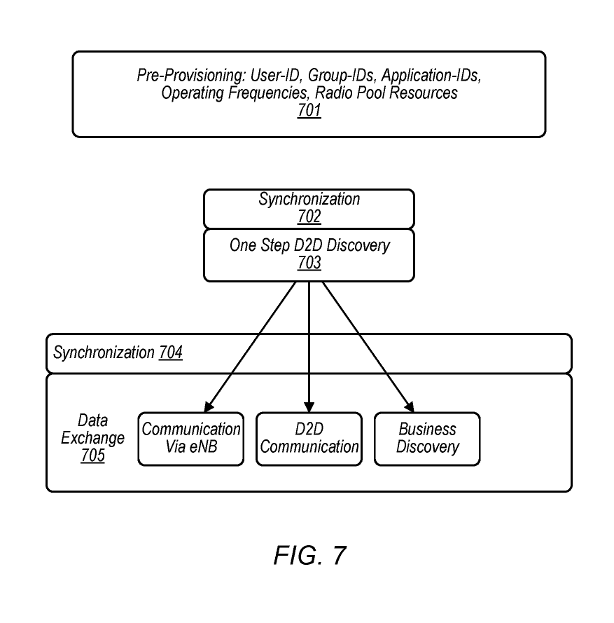

FIG. 7 illustrates various possible device-to-device communication related operations in an exemplary cellular network supported device-to-device communication framework, according to some embodiments. As shown, one such operation may include pre-provisioning (701), e.g., in which a UE device is provided (e.g., by a cellular network to which it is subscribed) with user identification information, group identification information, application identification information, D2D operating frequency information, radio pool resources, etc. Once pre-provisioned, a UE may perform synchronization (702) and D2D discovery (703). Once discovery is complete, data exchange synchronization (704) may further occur, as well as actual data exchange (705), which may include any combination of communication by way of a base station (e.g., an eNB), D2D communication, or business discovery.

When a UE device is within coverage range of a cellular network (e.g., of a base station) in a cellular network supported device-to-device communication framework, synchronization for the UE device may be derived from downlink primary synchronization signals (PSS) and secondary synchronization signals (SSS) transmitted by a cellular base station. Outside network coverage areas, D2D synchronization signals may be transmitted by UEs to provide synchronization signals between D2D devices and to avoid interference. Examples of such synchronization signals may include, but are not limited to primary/secondary sidelink synchronization signals (PSSS/SSSS) and/or sidelink master information block (MIB_SL). In order to avoid multiple synchronization sources, a process may be defined to elect a single UE (e.g., a “SyncRef UE” or a “master UE”) within a given area to act as a synchronization source.

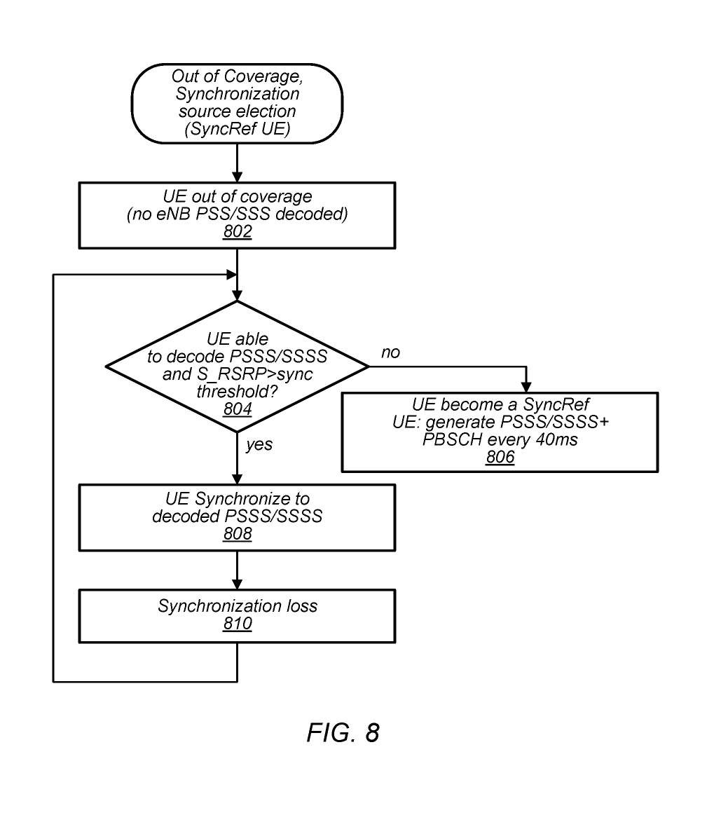

FIG. 8 is a flowchart diagram illustrating such an exemplary possible decision-making process for determining how to perform synchronization for device-to-device communications when out-of-coverage in an exemplary cellular network supported device-to-device communication framework, according to some embodiments. In various embodiments, some of the elements of the methods shown may be performed concurrently, in a different order than shown, may be substituted for by other method elements, or may be omitted. Additional method elements may also be performed as desired.

As shown, in 802, the UE device may determine that it is out of coverage (e.g., that no eNB PSS/SSS is decoded).

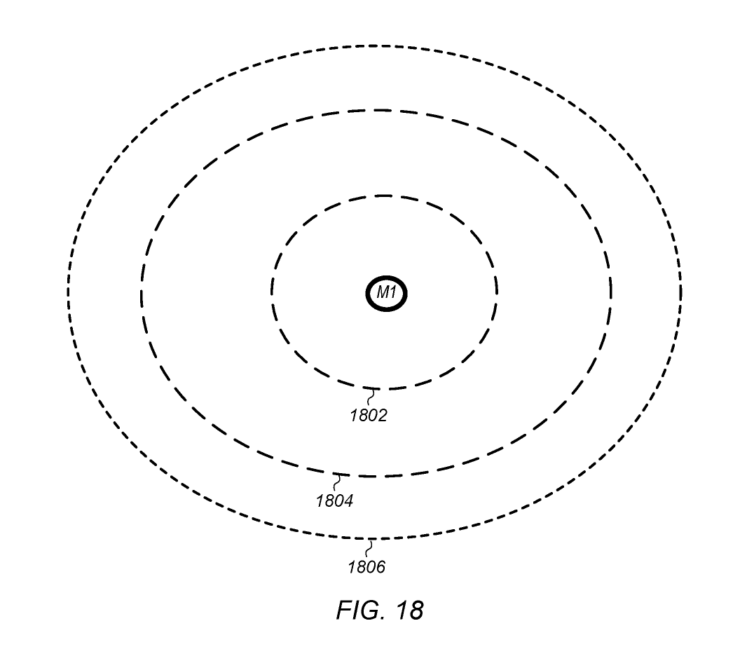

The UE may, in 804, determine whether it is able to decode any D2D synchronization signals (e.g., based on a determination that the UE device is out of coverage) with signal strength (e.g., Synchronization Reference Signal Received Power or “S_RSRP”) above a certain threshold (e.g., S_RSRP>sync threshold?). For example, in some embodiments, such a threshold may be S_RSRP>−130 dBm. For example, see also FIG. 18 and associated discussion below.

If the UE is unable to decode any D2D synchronization signals with sufficient signal strength, the UE may transition to 806, becoming a SyncRef UE and generating and transmitting D2D synchronization signals and physical sidelink broadcast channel (PSBCH) information (e.g., the MIB_SL) according to a specified periodicity (e.g., every 40 ms, as one of various possibilities).

If the UE is able to decode D2D synchronization signals with sufficient signal strength, the UE may transition to 808, synchronizing to the decoded D2D synchronization signals. Eventually, in 810, the UE may lose synchronization to these D2D synchronization signals, and the UE may return to step 804 to again determine whether another SyncRef UE is available or whether the UE will become a SyncRef UE.

### FIG. 9—Flowchart of Creating an Overlap Region

FIG. 9 illustrates an exemplary method for creating an overlap region at a cell's edge (e.g., at or near the boundary of a ProSe group or D2D group), such that certain UEs may repeat the D2D synchronization signals (e.g. NDPSS/NDSSS). Such a UE may be considered to be a “slave UE” for purposes of this description. In various embodiments, some of the elements of the methods shown may be performed concurrently, in a different order than shown, may be substituted for by other method elements, or may be omitted. Additional method elements may also be performed as desired.

The method may allow for the existence of a larger cell (e.g., D2D communication group, ProSe group, or OGRS group). Further, the method may allow for UEs that are in nearby cells to synchronize with the cell, discover UEs within the cell, and communicate with the discovered UEs.

In 902, a UE (e.g., UE 106A or 106B) receives D2D synchronization signals (e.g. NDPSS/NDSSS). The D2D synchronization signals may be transmitted by a “master” UE, e.g., of a cell. As noted above, in a cell, one UE may be the master (e.g., SyncRef UE) and other UEs may be slaves. The master may transmit (e.g., broadcast) D2D synchronization signals (e.g. NDPSS/NDSSS).

Thus, the received D2D synchronization signals may be those transmitted by the master UE of the cell. The received synchronization signals may include identifying information about the master UE, such as a cell identification (e.g., “cell_id”). For example, the master UE may be thought of as M1 with cell_id(M1) and the synchronization signals may contain cell_id(M1). For a graphical example, see FIG. 11 and related discussion below.

The slave UE may or may not also receive other synchronization signals (e.g., PSS/SSS). The slave UE may or may not be OOC, e.g., it may or may not be able to detect and synchronize with one or more base stations. The slave UE may also receive D2D synchronization signals transmitted by the master UE of another (e.g., a second) cell.

In 904, the slave UE may compare a received signal power metric for the D2D synchronization signals to one or more thresholds. According to various embodiments, the metric may be reference signal strength indicator (RSSI), RSRP (reference signal received power), synchronization RSRP (S_RSRP), among various possibilities. S_RSRP may be thought of as RSRP measured for synchronization signals instead of reference signals such as those commonly transmitted by a base station.

The slave UE may determine that the metric is greater than a sync threshold, e.g., used to determine whether the UE should be a master node, e.g., as described in FIG. 8. In other words, the UE may determine to join a group of the master node, e.g., and not to create a new cell/group. For example, the UE may compare the received signal power metric of a nearby master to the sync threshold (e.g., a “master threshold” or “broadcast threshold”), and if the power metric is greater than the sync threshold, the UE may join the group and become a slave UE.

The slave UE may determine that the received signal power metric is less than another threshold, e.g., a rebroadcast threshold. Note that the rebroadcast threshold may be different than the sync threshold. The slave UE may compare the received signal power metric (either the same one or one received/measured at a different (e.g., later) time; different metrics may also be used) to the rebroadcast threshold, which may be higher than the sync threshold. In some embodiments, if the slave UE is too close to the master UE, then the received signal power metric will be greater than the rebroadcast threshold. However, if the slave UE is near the edge of the cell range of the master UE, then the received signal power metric may be less than the rebroadcast threshold. Thus, the slave UE may determine that the received signal power metric is below the rebroadcast threshold. This threshold may be useful to ensure that only those slave UEs that are able to materially expand the boundaries of the cell (see discussion of 908, below) spend resources to do so.

Stated differently, in some embodiments, the rebroadcast threshold may be used in combination with the sync threshold. For example, the rebroadcast threshold may be higher than the sync threshold, thus creating a band of received signal power: only those UEs with received signal power above the sync threshold and below the rebroadcast threshold will fall within the band. This band may correspond to the edge or boundary of the cell associated with the master UE device. UEs with received signal power below the sync threshold may not synchronize to the cell, e.g., because they are too far from the master. UEs with received signal power above the rebroadcast threshold may be in the interior of the cell, as opposed to being at or near the edge of the cell. UEs with received signal power between the thresholds may determine that they are within the edge/boundary region of the cell, and therefore may be able to expand the boundary of the cell by rebroadcasting synchronization signals. For further information on this subject, please see FIG. 18 and associated discussion.

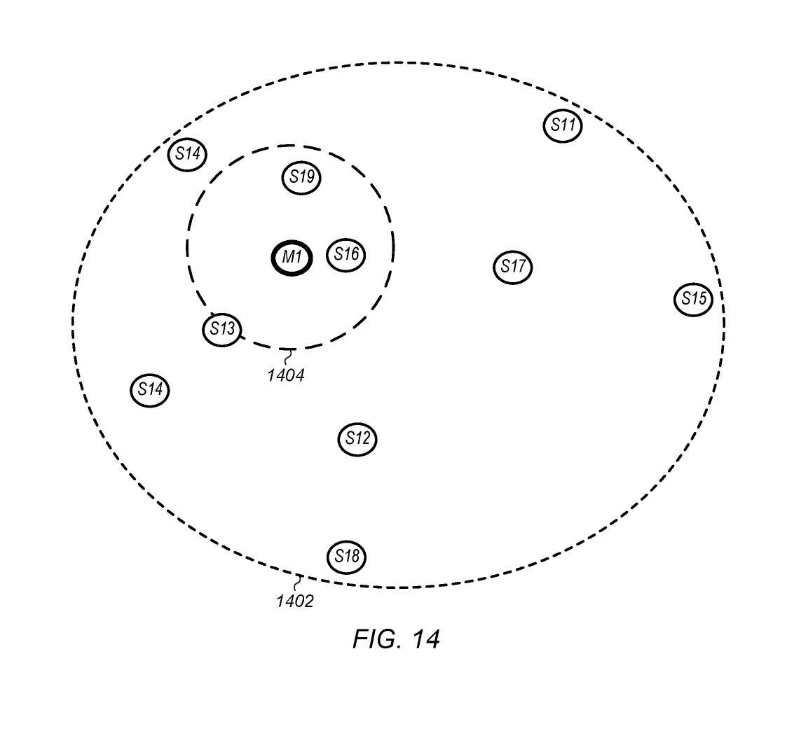

In 906, the UE may shift the cell_id of the D2D synchronization signals (e.g. NDPSS/NDSSS), e.g., the UE may create a different synchronization sequence. In some embodiments, the shifted cell_id of the synchronization signals may be based on the received synchronization signals. For instance, the shifted cell_id synchronization signals may be based on the cell identification (e.g., cell_id) of the received signals. For example, in some embodiments, the shifted synchronization signals (e.g., corresponding to a different sequence) may be created as follows: cell_id(M12)=cell_id(M1)+100. In this example, cell_id(M1) may represent the identity of master UE (e.g., “M1”) and cell_id(M12) may represent the identity of the UE. In this example, the UE may be considered to be a second representative, e.g., a repeater for the master. Thus, the UE may be labeled as M12 to indicate its relation to M1. Note that this example is depicted in FIG. 13, and is described with additional detail below.

In some embodiments, cell_ids may indicate various characteristics of the master and/or repeater UEs and the groups, e.g., various groups of cell_ids may be used. For example, a first group (e.g., cell_ids 1 to 100) may represent master UEs that are using a Global Navigation Satellite System (GNSS). A second group (e.g., cell_ids 101 to 200) may represent repeater UEs of the first group. A third group (e.g., cell_ids 201 to 300) may represent master UEs that are not using a GNSS. A fourth group (e.g., cell_ids 301 to 400) may represent repeater UEs of the third group. The distinction between masters using GNSS or not may be important for determining timing. In particular, if slave UEs know that GNSS is used by a master, the slave UEs may be able to derive the system frame number (SFN) from GNSS, and thus may not need to read the MIB to determine SFN. Among other possibilities, devices that are indoors may not have access to GNSS.

Note that these groups of cell_ids and the divisions of numbers in each group are exemplary only. Numerous other possible groups and representations are also possible. For example, one group of cell_ids could be used for master and/or repeater UEs with various characteristics, e.g., low or high transmission power or with low or high battery life. Other possible groups of cell_ids could represent different levels of congestion or interference, e.g., due to the number of UEs in the cell or in the vicinity. Still other possible groups could indicate different types of UEs (e.g., smart phones vs wearable devices vs machine-type-communication devices, etc.). Still other groups of cell_ids could represent different types or groups of users, such as first responders, military users, or employees of a company compared to the general public. Still other groups may be set up for special events such as sporting competitions. Still other groups may be used to provide different levels of priority, e.g., different levels of service or privacy. Still further groups may be set up for various custom purposes.

In some embodiments, the shift of the cell_id of D2D synchronization signals may be determined in various ways (e.g., by various offsets) based on the group(s) of the master UE and of the UE (e.g., of the repeater UE). For example, cell_ids and/or D2D synchronization signals may always be offset by a known amount (e.g., a consistent amount known by all UEs), such as by using a cell_id shift of 100 or any other desirable formula or number. This shift in cell_id may automatically result in a change in synchronization signal broadcast that may not conflict with the original master's synchronization signal broadcast (which may also be based on the original cell_id). In some embodiments, the offset used to shift the cell_id of the D2D synchronization signals may be zero. Such a zero offset may result in synchronization signals that are identical to those of the master's synchronization signal broadcast, e.g., the shifted cell_id may be the same as the cell_id of the received D2D synchronization signals.

In 908, the UE may broadcast the shifted cell_id in D2D synchronization signals. In some embodiments, the UE may use different time and/or frequency resources (e.g., subframes) to broadcast the synchronization signals than the master UE in order to reduce interference and collisions. Wireless devices may calculate the shifted cell_id from the D2D synchronization signals, e.g., using one or more formulas (e.g., cell_id=primary sync sequence+3*secondary sync sequence, among various possibilities).

This broadcast of the shifted cell_id synchronization signals may allow other (e.g., additional) wireless devices to synchronize to the cell. Thus, this broadcast of the shifted signals may also allow other wireless devices to discover some or all of the UEs in the cell. Further, this broadcast of the shifted signals (e.g., with shifted cell_id) may allow communication between more UEs. For example, other wireless devices (e.g., otherwise outside the cell, e.g., which were previously in other cells that were unavailable for discovery) may be able to communicate with some or all of the UEs in the cell. In some embodiments, the shift of the cell_ids and/or D2D synchronization signals may impart information to receiving UEs that assists (e.g., enables them) to synchronize with, discover, and communicate with UEs in the D2D communication group. In particular, the receiving UEs may determine that the shifted cell_id D2D synchronization signals are shifted relative to the original D2D synchronization signals transmitted by the master (e.g., that the received cell_id is shifted relative to the original or master cell_id). The receiving UEs may thus determine the original (e.g., unshifted) cell_id and/or D2D synchronization signals. The receiving UEs may determine the cell_id (e.g., and/or other characteristics) of both the master UE and the repeater UE. The receiving UEs may determine the shift, e.g., the offset between the shifted cell_id and unshifted cell_id based on the received D2D synchronization signals. The receiving UEs may use other information (e.g., knowledge of the various shifting schemes described above) to make this determination of the offset. Alternatively, the receiving UEs may use the offset between the shifted cell_id and unshifted cell_id signals to determine the cell_id or other characteristics of the master.

Further, the UEs may determine characteristics (e.g., configuration information) of the cell based on the synchronization signals (e.g., shifted or unshifted, as applicable). Such characteristics may include system frame number (SFN), discovery resources (e.g., the time and/or frequency location of resource blocks or PRB pairs, etc.) used for discovery, the resources used for paging, resources used for control communications, resources used for MIB, resources used for sending beacons and indications, resources used for acknowledgements (e.g., ACK and/or NACK), resources used for data transmission, and other various possibilities. In order to determine these characteristics, the UEs may use any of various techniques including using a formula or table to determine MIB resources based on the cell_id, among other possibilities. In some embodiments, the cell_id may indicate the SFN of the MIB and the reference symbols used for MIB. In some embodiments, the cell_id may indicate the frequency channel for discovery in the D2D communication group (e.g, in 900 MHz bands, there are multiple channels). The UEs may synchronize with the cell. The receiving UEs may thus be able to selectively monitor the resources (e.g., discovery channels) in use by other devices in the cell, and to ignore other resources (e.g., possibly including resources used by other cells in the vicinity to which the UE may not be synchronized or unused resources). The receiving UEs may thus be able to discover other UEs or devices in the cell and then communicate (e.g., send and receive data) with such other devices. In some embodiments, after the discovery phase, there may be a link establishment procedure between two or more UEs to determine resources (e.g., PRBs) for data communications. The UEs may send and/or receive control information (e.g., pages, ACKs, etc.) about the cell and communications in the cell. In effect, the broadcast (e.g., of the shifted cell_id D2D synchronization signals) may expand the boundaries of the cell. The broadcast of the shifted cell_id signals may be thought of as a rebroadcast of the original D2D synchronization signals because they may contain (e.g., or imply) some of the same information.

Further, some of the UEs that are slaves in another existing cell (e.g., a second cell or second D2D communication group) may be able to detect the broadcast shifted signals. These UEs may be considered to be in the “overlap region”. Therefore, such UEs may be able to synchronize to both cells, detect devices in both cells, and communicate with at least some devices in both cells. The ability of any particular pair of devices to detect one another and communicate may depend on various factors, including the distance in between them and the channel conditions.

In some embodiments, as described above, the use of the sync threshold in combination with the rebroadcast threshold may lead to only those UEs in a ring or band near the edge of the cell to broadcast the shifted signals. Thus, (e.g., because of the sync threshold) the cell topology may not be changed significantly (e.g., may not be changed too much) and the accuracy of timing may be maintained (e.g., because the effect of propagation is minimal).

In some embodiments, this method may be implemented by multiple nodes in series (e.g., in sequence or creating a chain). For example, a first master may broadcast D2D synchronization signals. A first repeater may receive those signals, determine that the received signal power metric is less than a threshold, and shift and broadcast the shifted signals. A second repeater may receive the shifted signals, determine that the received signal power metric is less than a threshold, further shift the received shifted signals, and broadcast the further-shifted signals, etc. In some embodiments, techniques may be employed to control such serial shifting and repeating. For example, a maximum number of relays may be set, a maximum timing or propagation delay may be implemented, or other (e.g., and/or additional) possible controls may be enforced. In some other embodiments, such serial shifting and repeating may not be permitted.

### FIG. 10—Flowchart of Handoff of Master Role

FIG. 10 depicts a process for handoff of the role of master (e.g., of SynchRef) UE according to some embodiments. In various embodiments, some of the elements of the methods shown may be performed concurrently, in a different order than shown, may be substituted for by other method elements, or may be omitted. Additional method elements may also be performed as desired.

In 1002, a UE (e.g., UE 106) may broadcast D2D synchronization signals (e.g. NDPSS/NDSSS). The UE may be the master or SynchRef UE of a cell. The UE may broadcast D2D synchronization signals periodically (e.g., at consistent or variable intervals or continuously) for any amount of time.

For one or more of numerous possible reasons, the UE may initiate a process to identify a new (e.g., successor) master UE. Such reasons may include expiration of a timer (e.g., a local timer or a global timer, e.g., a master may be selected for a fixed or variable period of time) or conditions of the UE (e.g., remaining battery power, activities of the user, activities of one or more applications executing on the UE, movement of the UE, etc.). For example, a UE may determine not to continue as master if the UE begins travelling rapidly due to the potential effects of such movement (e.g., a need to continuously change topology). Further, such reasons may include various conditions of the cell such as number of UEs, link quality (e.g., RSSI, RSRP, CQI, SINR, etc.) with one or more UEs in the cell, link quality with one or more UEs outside the cell or in other cell(s), and/or link quality with one or more base stations or access points. A local timer (e.g., at the UE) may be started when the UE assumes the master role, and at expiration of the timer, the UE may initiate the handoff process. A global timer may be established (e.g., based on coordinated universal time (UTC) time) and may be defined in the OGRS system. Based on such a global timer, all nodes may be aware of expiration of the timer and may accordingly anticipate the handoff process. For example, a global timer may be set such that handoff occurs every three minutes (e.g., although any interval may be used). Such global timers may be defined such that all OGRS groups perform handoff: at the same time; so that nearby groups perform handoff at different times (e.g., group 1 performs handoff at time=1 minute, group 2 at time=2 minutes, group 1 again at time=3 minutes, etc.); or at random times, among various possibilities. The UE may detect one or more conditions (e.g., handoff conditions, e.g., based on a timer (global or local), movement of the UE, battery level or other conditions of the UE, radio link conditions, etc.) consistent with any of such reasons, or other reasons, that indicate that a new master should be selected.

To initiate the process of handover, the UE may, in 1004, transmit one or more indications that it will cease broadcasting D2D synchronization signals. This indication may be sent in a dedicated time-slot (SFN)/frequency channel. The indication may include information that the master will stop transmitting the synchronization signals at a specified time, e.g., in a certain number of D2D synchronization signals cycles. This indication may be like a paging indication (e.g., the periodicity of the message may depend on the power consumption). The indication may be referred to as a beacon.

The indication may take various forms. For example, in some embodiments, the indication may be a PRACH preamble or similar to one. For example, an indication (e.g., a preamble) may be as defined in narrowband internet-of-things (NB-IoT), or various standards. Alternatively, or additionally, the indication may be a Zadoff-Chu (ZC) sequence with an index that is a function of the cell_id of the master.

In some embodiments, the indication may be configured to cause some or all of the slave UEs in the cell to identify themselves as the potential master nodes (e.g., candidate UEs). For example, in some embodiments, only the slaves close to the master may be eligible to become the successor group master. The area (e.g., the group of candidate UEs) may be based on received signal power metrics such as S_RSRP. For example, a threshold value (e.g., a candidate threshold) of one or more metrics may be used. For example, the subset of candidate UEs may be those whose S_RSRP is greater than a candidate threshold value. Setting such an area or threshold may minimize the change in group topology when the group master changes and may reduce the effect of error in timing propagation.

In some embodiments, the indication may specify a method, including timing, for responses. For example, the indication may specify a window (e.g., a consecutive number of subframes and/or a set of subcarriers) where the potential master nodes (e.g., candidate UEs) should reply. Such a window may be dimensioned or configured, e.g., the number of slots and/or subcarriers defined, at least in part based on the number of nodes near the master. For example, in the case of dense deployment where the number of UEs near the master is large, the number of slots in the window may be large in order to reduce the chance of collisions among responses.

Further, the indication may specify that the candidate UEs reply using a specific message type, e.g., an ACK. In some embodiments, additional information (e.g., about the condition of the UE, such as battery level, transmission power, movement speed, among other possibilities) may be required in the reply. Alternatively, in some embodiments, a simple reply (of the specified format and timing) may be sufficient.

The indication may be configured to cause the candidate UEs to randomly (e.g., or pseudo-randomly) select a time slot and/or subcarrier within the specified window to reply. Accordingly, each of the candidate UEs may use parameters such as UTC time or their identification to pseudo-randomly select a time slot and/or subcarrier.

In some embodiments, the candidate UEs may also use historical information to determine whether, when, or how to reply. For example, a UE may respond (e.g., or may not respond) based on whether or how recently it has been master. For example, a candidate UE may not respond if it: 1) was the previous master, 2) has ever been master, 3) has been the master within a first threshold amount of time, or 4) has been master of the group or any group for a cumulative amount of time exceeding a second threshold, among other possibilities. Based on such considerations, the candidate UE may decline to reply to an indication, even if it otherwise would be eligible to be a successor master. Alternatively, a UE that has been master recently (e.g., or based on any of the considerations above) may adjust the pseudo-random parameters for its time slot and/or subcarrier selection to result in a later time slot. Such an adjustment may have the result of reducing the probability that the UE will be elected master again. For example, the UE may use a bias in the random number generator to make it more likely to choose a later slot than an earlier slot within the specified window. The pseudo-random number may also depend on the state of the charge of the battery. For example, if the battery charge is low, the probability of the UE becoming the master may also be low.

The indication may be transmitted one or more times, as needed. If the indication is transmitted more than once, the content of the indication may or may not be changed between transmissions. In some embodiments, the indication may be transmitted multiple times prior to the beginning of the window for replies. Such repetition may increase the probability that all candidate UEs successfully decode the indication.

In some embodiments, e.g., if a global timer is used, no indication may be transmitted. For example, based on a globally defined timer and handoff sequence, all devices in the OGRS group may know how and when the handoff will occur. Thus, candidate UEs may be configured to participate in the selection process, e.g., according to the global definition.

In 1006, the UE may receive at least one response, e.g., to the one or more indications or based on a globally defined handoff sequence, from at least one wireless device. The at least one response may be sent by the successor master, e.g., the UE selected to begin broadcasting D2D synchronization signals.

In some embodiments, the first candidate UE to reply (e.g., to transmit a response) may be selected to become the next master. This selection may occur automatically. For example, the candidate UEs may be configured (e.g., in advance or by the indication) to recognize that the first UE to reply (e.g., or the UE to reply in the lowest or highest subcarrier) will become the next master. Additionally, or alternatively, the UE to reply in the lowest numbered (e.g., or highest numbered, etc.) subcarrier. In some embodiments, a first dimension (e.g., time or time slot) may be used as the primary determinant of the outcome (e.g., for selecting a successor master) and a second dimension (e.g., subcarrier) may be used as a tie breaker, e.g., as the basis for selecting a master in the case that the first dimension does not yield an unambiguous result. In some embodiments, the first dimension may be used in combination with the second dimension in order to reduce the likelihood of collisions. For example, UEs may reply in a random time slot using a predetermined (e.g., or non-random) subcarrier; in this example, assignment of subcarriers may serve to reduce the probability of collisions.

In some embodiments, the UEs in the vicinity may know that a new master is elected because of one or more of the following reasons, among other possibilities: the beacon may not be transmitted anymore, they may be able to decode the responses (e.g., ACK messages), and/or the D2D synchronization signals (e.g., the Sync preamble) may be transmitted uninterrupted. In some embodiments, if two (e.g., or more) candidate UEs reply in the same timeslot (e.g., the replies may collide), it may be necessary for the UE to retransmit the indication, and set a new window for replies. Alternatively, a new window for replies may be defined (e.g., globally and/or in the initial indication) and no further indication may be necessary. In the case of a collision and consequent new window for replies, each of the candidate UEs may reselect timeslots in the new window for their new reply. Thus, the indication may be retransmitted as many times as necessary to identify a successor master. For example, if the master is not able to decode the ACK (e.g., because of poor radio conditions, or because of collision), the master will resend the beacon. In some embodiments, the master may stop sending the beacon as soon as it is able to decode an ACK correctly. For example, if after the first beacon attempt, the master was able to decode the ACK, it may not transmit the beacon again.

In some embodiments, the ACK message from different UEs may be multiplexed in frequency and/or time dimensions. For example, in NB-IoT, there may a possibility of sending an ACK on a single subcarrier. Hence each ACK message may occupy a single subcarrier (e.g., there may be either 48 subcarriers of 3.75 KHz or 12 subcarriers of 15 KHz) among various possibilities, and several ACKs may be transmitted and received concurrently.

As a further example, according to some embodiments, in a scenario of continuous collision of responses in all (e.g., multiple, consecutive) beacon transmission attempts, the master may stop sending the D2D synchronization signals, and the initial procedure for master election (e.g., the method of FIG. 8) may be repeated. There may be a small interruption of the D2D synchronization signals (e.g., sync preamble) transmission.

Alternatively, in the event that no replies are received, it may be the case that there are not many (e.g., or not any) UEs in proximity of the master (e.g., the density is small, e.g., is low). Thus, it may make sense for the topology to change. Accordingly, in this event, the UE may cease transmitting synchronization signals. Therefore, remote UEs wanting to communicate may then scan for a synchronization source (e.g., another master) and then decide to become a master or to synchronize with another master.

In 1008, the UE may cease to broadcast D2D synchronization signals (e.g. NDPSS/NDSSS).

Upon ceasing to broadcast the D2D synchronization signals, the UE may no longer be acting as the master of the group. The successor master may take on the role of master, and, in particular may begin to broadcast D2D synchronization signals. Thus, the handshake mechanism to change masters may be complete at this point.

Importantly, in at least some embodiments, the method of FIG. 10 may be implemented in conjunction with the methods of FIGS. 8 and 9. The methods may interact in myriad ways. For example, following a change in master of at least one group, there may also be a change in the UEs that relay synchronization signals for that group as well as for other groups in the vicinity. Similarly, a change in the relay of one group may lead to a change in master of another group, the creation of one or more new groups, or the elimination of one or more existing groups. In a region with numerous nodes and multiple groups, there may be many potential combinations and permutations of how a change (e.g., or multiple changes) in one group may impact other nodes and groups according to one or both of these methods. All such combinations and permutations may be encompassed within the intended scope of this disclosure.

Alternatively, in at least some embodiments, the method of FIG. 10 may be implemented in conjunction with a method such that a plurality of D2D communication groups all use the same, single cell identification (e.g., cell_id) for communication. In such an embodiment, in order to limit the impact of interference and collisions at the cell boundaries, the number of resources may need to be increased. For example, consider a case such that L may be the maximum (max) number of cells that create interference at a cell edge. Further, in the exemplary case, every cell may use one channel for discovery with an X % duty cycle. In the case of different cell_ids, L discovery channels may be needed. However, in the case that all cells use a single cell_id, a single channel with LX % duty cycle may be needed. Thus, the number of resources used for discovery may be the same. However, in the case of different cell_ids, the UEs may monitor only the discovery channels to which they can synchronize. In contrast, for a single cell_id scenario, a static design of number of channels/resources may be needed since the load of UEs is not known. Therefore, the single cell_id scenario may require the UEs to monitor all discovery resources. Thus, the multiple cell_ids method may, in comparison to the single cell_id method: 1) reduce the power consumption, and/or 2) reduce the latency (or time needed to discover the UEs). It may be desirable to quantify the difference in performance further than in this high-level comparison of the different scenarios.

### FIGS. 11-15—Example D2D Groups

FIG. 11 illustrates aspects of an exemplary possible OGRS communication system, according to some embodiments. As shown, the system may include a first D2D communication group (e.g., OGRS group) 1102. As shown, the system may include 5 nodes: M1, S11, S12, S13, and S14. Node M1 may be the master node and the remaining nodes may be slave nodes. As described above, the master in a group may transmit synchronization channels to other members in the group, and any devices that wish to join the group, may obtain synchronization. For example, the synchronization channel(s) may assist with bringing all the members in the group to a common frequency and time, and may be helpful to the nodes in the group for later communication. As shown, M1 may broadcast D2D synchronization signals (e.g. NDPSS/NDSSS) using cell_id1. All included nodes may be able to synchronize, discover, and communicate with one another.

FIG. 12 illustrates the first D2D communication group (1102) as in FIG. 11, and a second D2D communication group 1204. The second group may include master node M2 and slave nodes S21, S22, S23, and S24. As shown, M2 may broadcast D2D synchronization signals using cell_id2. The two OGRS groups may operate independently. Notably, some devices in the first group (e.g., S14) may be in close proximity of some devices in the second group (e.g., S22). However, as shown, S14 and S22 may not be synchronized, and thus may not be able to discover or communicate with each other.

FIG. 13 depicts a mechanism (e.g., the method of FIG. 9, above) by which an overlap region at the edge of a D2D communication group may be created, thus potentially extending synchronization to additional devices. The first and second D2D communication groups (e.g., 1102 and 1204) are depicted as in FIG. 12. Slave node S14 may broadcast shifted cell_id D2D synchronization signals, based on cell_id1. The shifted signals (e.g. NDPSS/NDSSS) may provide information (e.g., timing) as necessary for other nodes (e.g., S22 and any other nodes inside group 1306) to synchronize with M1, and thus may allow such other nodes to discover and communicate with the nodes of group 1102. In this regard, S14 may be thought of as M12 because it relays (e.g., repeats, retransmits, or rebroadcasts) shifted cell_id synchronization signals of M1. In particular, S22 may be able to synchronize, discover, and communicate with other nodes synchronized with M1 (e.g., group 1102 {e.g., including M1, S11, S12, and S13} and group 1306) as well as those synchronized with M2 (e.g., group 1204). Thus, S22 may be considered to be a member of each of groups 1102, 1204, and 1306.

Similarly, node S23 may broadcast shifted cell_id D2D synchronization signals, based on cell_id2, and may be thought of as M22 (e.g., a repeater of M2). S23/M22 may therefore create group 1308, which may bring an additional node S222 into synchronization with M2. S222 may be able to discover and communicate with other nodes in groups 1308 and 1204.

According to some embodiments, S22 will sync with M12 and therefore may not relay shifted cell_id synchronization based on cell_id2 (e.g., will not repeat M2's synchronization) if the S_RSRP (e.g., or other metrics) measured based on the new M12 sequence is stronger (e.g., higher) than that of M2. Additionally, in some embodiments, S22 may repeat M1's synchronization, e.g., shift and transmit synchronization signals based on the D2D synchronization signals of S14/M22. Alternatively, in some embodiments, if the S_RSRP of M2 is stronger, S22 may shift and broadcast shifted D2D synchronization signals, based on cell_id2.

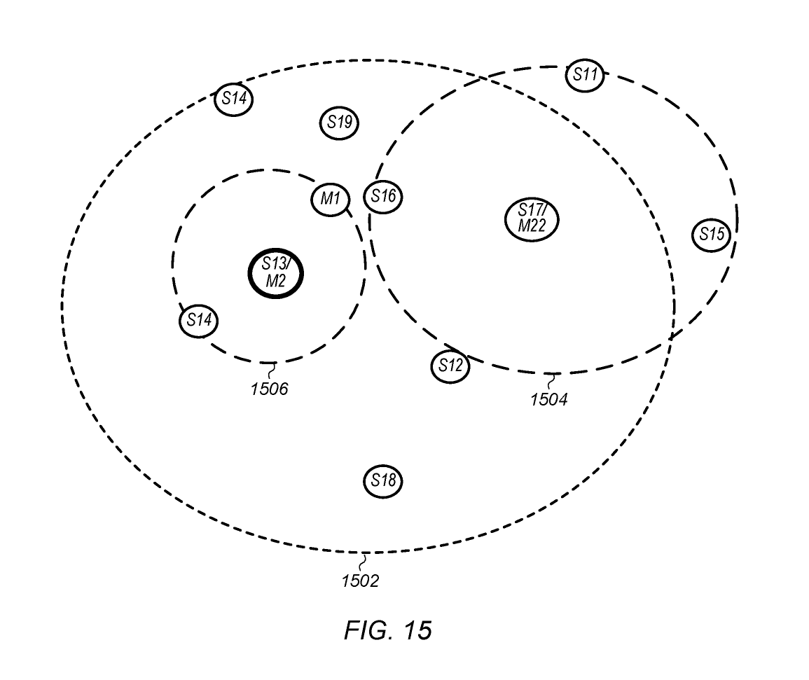

FIGS. 14 and 15 depict a different D2D communication group, undergoing a change of masters according to the method described above and shown in FIG. 10. Further, FIG. 15 also depicts a new relay to extend the group according to the method of FIG. 9.

FIG. 14 depicts D2D communication group 1402 in its initial state, prior to the transition. Node M1 may be the master, and slaves S11-S19 may be included (e.g., are synchronized in the group). Group 1404 (e.g., S13, S16, and S19) may define the subset of candidate nodes to become the next master. For example, group 1404 may be the subset of UEs whose S_RSRP is greater than a threshold (e.g., a candidate threshold) value. In other words, group 1404 may be the nodes who detect M1's synchronization signals with a measured S_RSRP greater than the candidate threshold.

FIG. 15 depicts the same set of nodes, showing how the topology may change based on a change in master. As shown, S13 may become the new master (and is thus relabeled S13/M2) and group 1502 may depict all nodes that are able to directly synchronize with S13/M2.

Notably, not all nodes of the previous group may be included; in particular, two nodes (e.g., S11, S15) of the previous group 1402 fall outside of group 1502, as illustrated. Thus, according to the method of FIG. 9, UE S17 (e.g., now S17/M22) may begin to shift the synchronization of S13/M2 and broadcast the shifted cell_id signals. New group 1504 may therefore be created by S17/M22, and may include S11 and S15, as well as S16.

Group 1506 may be the candidate nodes for replacing S13/M2 as master in a subsequent transition.

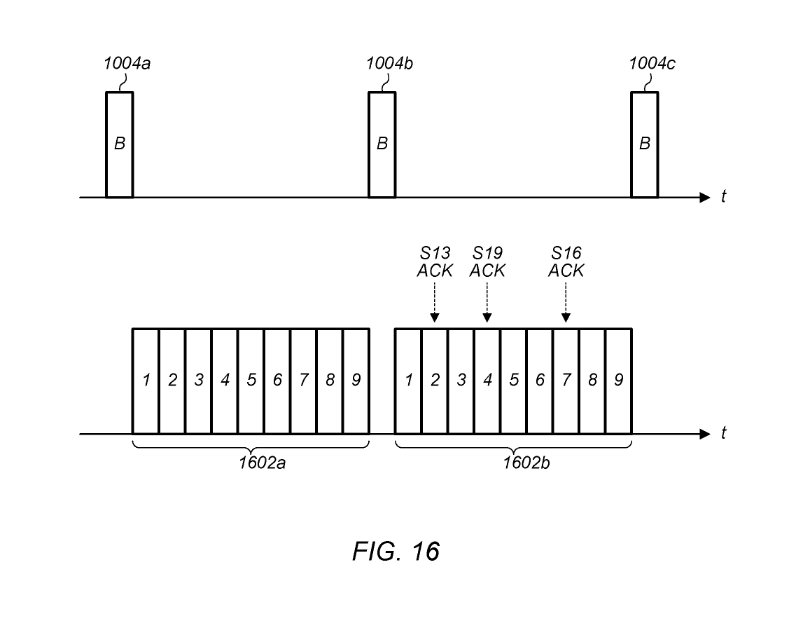

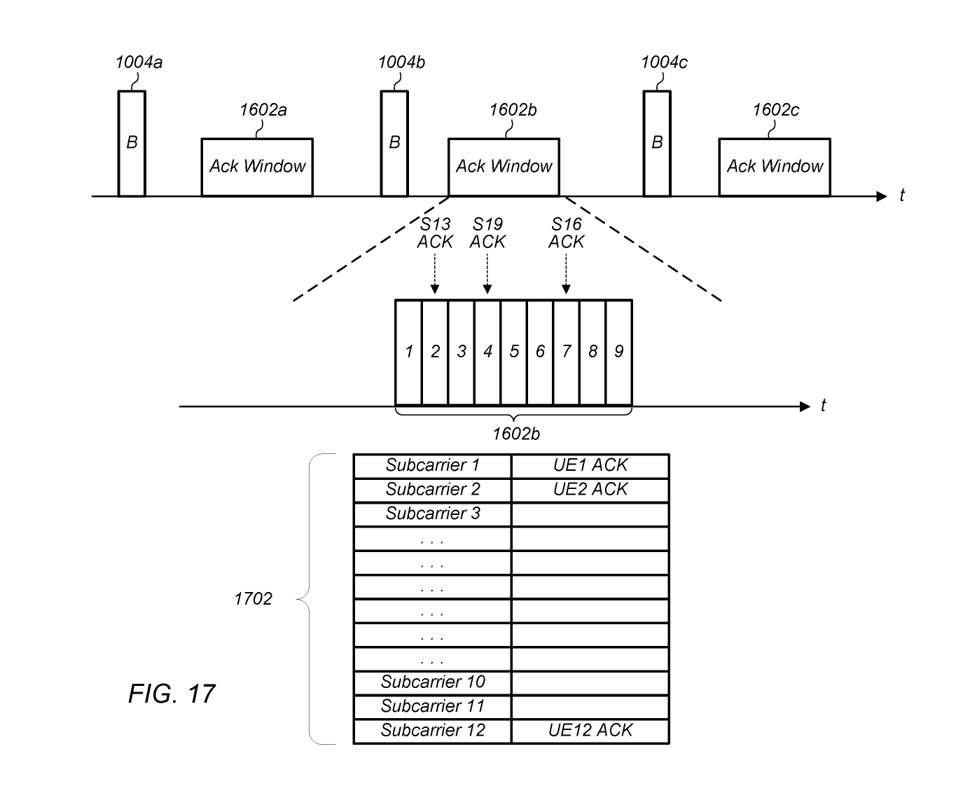

### FIGS. 16 and 17—Message Timing

FIG. 16 depicts a timing diagram, providing further detail about a possible embodiment of a handoff of the master role in a D2D communication group (e.g., according to the method of FIG. 10). The master may transmit indications (e.g., beacons {B} 1004a-c) to indicate that it will cease broadcasting D2D synchronization signals. For example, indications 1004a and 1004b may indicate that candidate UEs should respond with an ACK during time window 1602b (showing timeslots numbered 1-9). In some embodiments, no beacons may be transmitted. Time window 1602a may be used for other purposes; for example, the master UE and candidate UEs may sleep during this time or may transmit/receive data unrelated to the transition (e.g., handoff) of the master role. As shown, node S13 may respond with an ACK in timeslot 2; S19 may respond in timeslot 4, and S16 may respond in timeslot 7. As shown, there may be no collisions between responses, and node S13 may be selected as the successor master (e.g., because S13 responded earliest, e.g., based on a pseudo-random selection of timeslot 2). Therefore, a third indication (e.g., indication 1004c) may not be necessary in this exemplary case. As a result, S13 is selected as the new master, as shown in FIG. 15. As will be appreciated, other selection rules are possible (e.g., last candidate to respond may be selected), according to some embodiments.

FIG. 17 depicts a timing diagram, with still further detail about a possible embodiment of a handoff of the master role in a D2D communication group (e.g., according to the method of FIG. 10). The master may transmit indications (e.g., beacons {B} 1004a-c) to indicate that it will cease broadcasting D2D synchronization signals, e.g., at a specified time or after a new master is elected. For example, indications 1004a and 1004b may indicate that candidate UEs should respond with an ACK during time window (e.g., Ack Window) 1602b (including timeslots numbered 1-9). In some embodiments, no beacons may be transmitted. Time window 1602a may be used for other purposes; for example, the master UE and candidate UEs may sleep during this time or may transmit/receive data unrelated to the transition (e.g., handoff) of the master role. As shown, node S13 may respond with an ACK in timeslot 2; S19 may respond in timeslot 4, and S16 may respond in timeslot 7. As shown, there may be no collisions between responses, and node S13 may be selected as the successor master (e.g., because S13 responded earliest, e.g., based on a pseudo-random selection of timeslot 2). Therefore, a third indication (e.g., indication 1004c) and window (1602c) may not be necessary in this exemplary case. As a result, S13 is selected as the new master, as shown in FIG. 15. Additionally, FIG. 17 depicts frequency range 1702. As noted above, beacons 1004 may indicate that UEs should reply via ACKs in specific (e.g., predetermined, assigned, or non-random) subcarriers or in random (e.g., pseudo-random) subcarriers. Accordingly, the subcarriers may be used for selecting the successor master (e.g., a node using a lowest or highest subcarrier may be selected) and/or they may be used to reduce the likelihood of collisions between responses (e.g., multiple responses at the same time may not use the same subcarrier).

### FIG. 18—Exemplary Threshold Ranges

FIG. 18 depicts various potential thresholds for a D2D communication group according to some embodiments of the methods described herein. A master UE (e.g., M1) broadcasts D2D synchronization signals (e.g. NDPSS/NDSSS). At increasing distances (e.g. ranges, or radiuses) from M1, the received signal power (e.g., S_RSRP) of the D2D synchronization signals of M1 may decline. Other UEs may measure received signal power metrics of the D2D synchronization signals and compare the metrics to various thresholds.

Range 1802 depicts the area inside of which a received signal power metric may exceed a first threshold, e.g., a candidate threshold. For example, the first threshold may be S_RSRP=−100 dBm, among other possibilities. According to some embodiments, UEs inside range 1802 may measure the S_RSRP of the D2D synchronization signals of M1 as >−100 dBm (e.g., greater than the candidate threshold), and therefore, these UEs may be candidates for becoming a successor master, e.g., following M1. Limiting the set of candidates to those within range 1802 may have benefits for power saving and reduced topology change, among others.

Range 1804 depicts the area inside of which a received signal power metric may exceed a second threshold, e.g., a rebroadcast threshold. For example, the second threshold may be S_RSRP=−120 dBm, among other possibilities. According to some embodiments, UEs inside range 1804 may measure the S_RSRP of the D2D synchronization signals of M1 as >−120 dBm (e.g., greater than the rebroadcast threshold), and therefore, these UEs may not shift the D2D synchronization signals of M1 and may not broadcast (e.g., rebroadcast or relay) the shifted cell_id signals. Instead, only those UEs outside of the rebroadcast threshold (e.g., outside of range 1804) may shift and broadcast the synchronization signals; these UEs (e.g., specifically the UEs outside of 1804 but inside 1806) may be thought of as being on the edge of the D2D communication group.

Range 1806 depicts the area inside of which a received signal power metric may exceed a third threshold, e.g., a sync threshold. For example, the third threshold may be S_RSRP=−130 dBm, among other possibilities. According to some embodiments, UEs inside range 1806 may measure the S_RSRP of the D2D synchronization signals of M1 as >−130 dBm (e.g., greater than the sync threshold), and therefore, these UEs may synchronize with M1 and may be members of the D2D communication group. According to some embodiments, UEs outside range 1806 may measure the S_RSRP of the D2D synchronization signals of M1 as <−130 dBm (e.g., less than the sync threshold), and therefore, these UEs may not synchronize with M1 and may not be members of the D2D communication group. The UEs outside of range 1806 may elect to synchronize with (e.g., or to become masters of) other D2D communication groups.

### EXEMPLARY EMBODIMENTS

In the following, exemplary embodiments are provided.

In one set of embodiments, a method by a first wireless device may comprise: receiving first device-to-device (D2D) synchronization signals for a D2D communication group, wherein the first D2D synchronization signals are provided by a second wireless device; determining that a received signal power metric of the first D2D synchronization signals is less than a first threshold; shifting a cell identification (cell_id) of the first D2D synchronization signals; and broadcasting second D2D synchronization signals, wherein said broadcasting is based at least in part on the determination that the received signal power metric of the first D2D synchronization signals is less than the first threshold.

In some embodiments, a method for a first master wireless device in a D2D communication group to handoff to a successor master wireless device may comprise: broadcasting D2D synchronization signals; transmitting one or more indications that the first master wireless device will cease broadcasting D2D synchronization signals; receiving at least one response to the one or more indications from at least one wireless device; and ceasing to broadcast D2D synchronization signals in response to receiving the at least one response.

In some embodiments, a single cell identification may be used for D2D communication within each of a plurality of D2D communication groups, including the D2D communication group.

In some embodiments, the indication may be configured to cause any candidate wireless device to transmit an acknowledgement (ACK) at a random time slot in a specified time window.

In some embodiments, a method for a first slave wireless device in a D2D communication group to become a successor master wireless device may comprise: receiving D2D synchronization signals; receiving one or more indications that a first master wireless device will cease broadcasting D2D synchronization signals; transmitting a first one or more responses to the one or more indications; selecting to become a successor master device; and broadcasting D2D synchronization signals as the successor master device.

In some embodiments, the method for a first slave device may further comprise: detecting a second one or more responses to the one or more indications from one or more second slave wireless devices, wherein selecting to become the successor master device is based on said detecting the second one or more responses.

In some embodiments, selecting to become the successor master device may be based on an order of a first response of the first one or more responses and at least one of the second one or more responses.

In some embodiments, the method for a first slave device may further comprise: determining that at least one of the one or more responses to the one or more indications comprises a first response transmitted by any of a set of candidate successor master devices.

In some embodiments, said transmitting the first one or more responses to the one or more indications may be based on a length of time since the first slave wireless device has been a master device.

In some embodiments, a method by a first wireless device may comprise: receiving device-to-device (D2D) synchronization signals for a D2D communication group, wherein the D2D synchronization signals are provided by a second wireless device; determining a cell identification (cell_id), wherein the cell_id is determined based at least in part on the received D2D synchronization signals; determining that the cell_id is a shifted cell_id, and determining characteristics of the D2D communication group.

In some embodiments, the method may further comprise, by the first wireless device: determining an offset of the shifted cell_id relative to an unshifted cell_id, and wherein the characteristics of the D2D communication group are determined based at least in part on the offset.

In some embodiments, the characteristics of the D2D communication group comprise at least one of: cell_id of a master device, discovery resources, master information block resources, control communication resources, or data transmission resources.

In some embodiments, the method may further comprise, by the first wireless device: synchronizing with the D2D communication group.

Another exemplary embodiment may include a wireless device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

In addition to the above-described exemplary embodiments, further embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106 or 107) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising a processing element configured to cause a first wireless device to:
receive first device-to-device (D2D) synchronization signals for a first D2D communication group, wherein the first D2D synchronization signals are provided by a second wireless device;
compare a received signal power metric of the first D2D synchronization signals to one or more thresholds;
shift a cell identification (cell_id) of the first D2D synchronization signals; and
broadcast second D2D synchronization signals using the shifted cell identification, wherein said broadcasting is based at least in part on the comparison of the received signal power metric of the first D2D synchronization signals to the one or more thresholds.

2. The apparatus of claim 1, wherein the comparison of the received signal power metric to the one or more thresholds indicates that the first wireless device is within a boundary region of the first D2D communication group.

3. The apparatus of claim 1, wherein the shifted cell identification indicates a characteristic of at least one of the first and second wireless device.

4. The apparatus of claim 1, wherein the second D2D synchronization signals indicate configuration information of the first D2D communication group.

5. The apparatus of claim 1, wherein the second D2D synchronization signals are broadcast on different time or frequency resources than the first D2D synchronization signals.

6. The apparatus of claim 1, wherein the processing element is further configured to cause the first wireless device to:
synchronize with a third wireless device, wherein the third wireless device is a member of a second D2D communication group different than the first D2D communication group; and
communicate with the third wireless device.

7. The apparatus of claim 1, wherein the shifted cell_id is the same as the cell_id of the first D2D synchronization signals.

8. An apparatus for managing a first master wireless device in a first device to device (D2D) communication group to handoff to a successor master wireless device, the apparatus comprising a processing element configured to cause the first master wireless device to:
broadcast D2D synchronization signals;
detect at least one handoff condition, wherein the at least one handoff condition indicates that a new master should be selected;
receive at least one response from at least one candidate wireless device; and
cease to broadcast D2D synchronization signals in response to receiving the at least one response.

9. The apparatus of claim 8, wherein the apparatus is further configured to cause the first master wireless device to:
transmit one or more indications that the first master wireless device will cease broadcasting D2D synchronization signals, wherein the indication is configured to cause any candidate wireless device to transmit a response at a random time slot in a specified time window, wherein said transmitting is in response to detecting the handoff condition.

10. The apparatus of claim 9, wherein the one or more indications specifies a method for responses.

11. The apparatus of claim 8, wherein the at least one response comprises an acknowledgement (ACK).

12. The apparatus of claim 8, wherein a single cell identification is used for D2D communication within each of a plurality of D2D communication groups, including the first D2D communication group.

13. The apparatus of claim 8, wherein the at least one handoff condition comprises expiration of a global timer, wherein the global timer is based on coordinated universal time (UTC).

14. An apparatus for managing a wireless device in a device to device (D2D) communication group, the apparatus comprising a processing element configured to cause the wireless device to:
receive D2D synchronization signals;
receive one or more indications that a first master wireless device will cease broadcasting D2D synchronization signals;
transmit a first one or more responses to the one or more indications;
determine to become a successor master device based at least in part on the first one or more response; and
in response to determining to become the successor master device, broadcast D2D synchronization signals as the successor master device.

15. The apparatus of claim 14, wherein the processing element is further configured to cause the wireless device to:
detect a second one or more responses to the one or more indications from one or more second slave wireless devices;
wherein becoming the successor master device is based on said detecting the second one or more responses.

16. The apparatus of claim 15, wherein becoming the successor master device is based on a comparison of a first response of the first one or more responses and at least one of the second one or more responses.

17. The apparatus of claim 16, wherein said comparison comprises using at least one of time and frequency.

18. The apparatus of claim 14, wherein said transmitting the first one or more responses is based on historical information.

19. The apparatus of claim 18, wherein the historical information comprises the length of time since the wireless device has been a master device.

20. The apparatus of claim 14, wherein to transmit the first one or more responses the processing element is further configured to cause the wireless device to select at least one of a time slot and subcarrier to transmit the first one or more responses.

21. The apparatus of claim 14, wherein the processing element is further configured to cause the wireless device to:
measure a received signal power metric of the D2D synchronization signals; and
compare the received signal power metric to at least one threshold, wherein transmitting the one or more responses is in response to the comparison.
